(19) United States
(12) Patent Application Publication
(10) Pub. No.: US 2022/0173455 A1
(43) Pub. Date: Jun. 2, 2022

(54) TEMPERATURE CONTROL PLATE HAVING A MICROSTRUCTURED FLUID CHANNEL, IN PARTICULAR FOR MOTOR VEHICLES

(71) Applicants: Reinz-Dichtungs-GmbH, Neu-Ulm (DE); Dana India Technical Centre PVT. LTD., Pune (IN)

(72) Inventors: Chetan PRASHANT, Neu-Ulm (DE); Harald REBIEN, Neu-Ulm (DE); Felix SENF, Neu-Ulm (DE); Bernd GAUGLER, Neu-Ulm (DE); Stephan WENZEL, Neu-Ulm (DE)

(21) Appl. No.: 17/593,789

(22) PCT Filed: Mar. 19, 2020
(86) PCT No.: PCT/EP2020/057606

§ 371 Date: Sep. 24, 2021

(30) Foreign Application Priority Data
Mar. 25, 2019 (DE) 20 2019 101 687.6

(51) Int. Cl. H01M 10/6556; F28F 3/04; F28F 13/12; F28F 3/12; F28F 13/18; H01M 10/613; H01M 10/625

(52) U.S. Cl. CPC H01M 10/6556; F28F 3/048; F28F 13/125; F28F 3/12; H01M 2220/20; H01M 10/613; H01M 10/625; F28F 2260/02; F28F 13/185

(57) ABSTRACT

A plate-like fluid container for guiding a fluid, container having two at least partially abutting layers, an inlet for inflow of the fluid into the fluid container and an outlet for outflow of the fluid from the fluid container, in particular at least intermittently continuous inflow and outflow of the fluid, whereby, between the layers along at least one recess present at least in one of the layers, at least one fluid channel associated with the recess is present for guiding a fluid from the inlet to the outlet.

The invention relates to a plate-like fluid container for guiding a fluid, in particular for controlling the temperature of a storage device for electrical energy or for controlling the temperature of an electronic control or regulating device, preferably in a motor vehicle, having two at least partially abutting layers, an inlet for inflow of the fluid into the fluid container and an outlet for outflow of the fluid from the fluid container, in particular at least intermittently continuous inflow and outflow of the fluid, whereby, between the layers along at least one recess present at least in one of the layers, at least one fluid channel associated with the recess is present for guiding a fluid from the inlet to the outlet.

In principle it is known to manufacture cooling plates used for cooling, but also for heating and thereby generally for controlling the temperature of a component adjacent to the cover plate, from metals as well as from plastics. For this purpose, for example, two metal plates, of which at least one has channel structures in the form of one or more recesses for forming a fluid channel, can be soldered or welded together to form the cooler plate. Hereby, a cavity between the two plates or layers results from the topology of the channel structures, which are designed in the form of one or more recesses in one or both of the plates, through which cavity a fluid can be guided, for example for cooling. Such cooling or temperature control plates can generally also be referred to as plate-like fluid containers for controlling temperature. For example, DE 10 2017 202 552 A1 discloses such a cooler plate, which can also be referred to as a plate-like fluid container for controlling temperature. The fluid channel can thereby be associated with the one or more recesses.

The invention is based on the object to improve the temperature control capacity of known cooling and/or heating plates, that is, known plate-like fluid containers for controlling temperature, in particular to achieve a desired temperature control capacity distribution in a targeted manner, for example, to avoid an unwanted temperature distribution inequality, or to modify a flow resistance in the fluid channel.

This object is achieved by the subject matter of the independent claim. Advantageous embodiments result from the dependent claims, the description and the figures.

One aspect relates to a plate-like fluid container for controlling temperature, that is for heating and/or cooling, in particular for controlling the temperature of a storage device for electrical energy or an electrical consumer such as an electronic control and/or regulating device. Preferably, the storage device or the electrical consumer is part of a motor vehicle, for example a motor vehicle having an electric drive motor.

“Plate-like” is understood here that the fluid container extends in a main extension plane having a specified length and width and the thickness of the fluid container perpendicular to the main extension plane is less than the length and/or width by a multiple, for example at least a factor of 10 or at least a factor of 50. Such a plate-like fluid container for controlling temperature can also be referred to as a temperature control plate and/or cooling plate and/or heating plate.

The fluid container thereby has at least two adjacent layers abutting in regions, for example metallic layers, but possibly also plastic layers or combinations of at least one metallic and one plastic layer, as well as an inlet for flowing the fluid into the fluid container and an outlet for the outflow of the fluid from the fluid container. Thereby, between the layers along at least one recess, thus one or more recesses present in at least one of the layers, thus in one layer or in both layers, at least one fluid channel associated with the recess is present to guide the fluid in a flow direction from the inlet to the outlet. The fluid channel can thereby have one or more fluid channel sections associated with the one or more recesses. Optionally, the guide direction can be reversed and the outlet can be used as an inlet.

The fluid channel thereby has a plurality of microstructures protruding into the fluid channel at least in regions, thus in regions or completely, in particular also in a plurality of regions or fluid channel sections separated from each other, on an inner wall contacting the fluid during the intended use.

Many temperature control plates have a surface facing the body being temperature controlled and a surface facing away from said body.

Microstructures can be present both on the inner wall facing the body being temperature controlled and on the inner wall facing away from the body being temperature controlled. Said microstructures are correspondingly arranged or mounted having a foot region at the respective assigned layer and a head region standing freely in the channel passing into the respective foot region via one or more side flanks of the microstructure. The microstructures can thus be arranged edgewise with the head region standing freely in the channel on the inner wall. The microstructures can thereby be produced both by means of a forming method and/or an applying (additive) method and/or an ablative method; in all three cases, the head region then formed by means of the forming method or applied by the applying method or exposed by means of the ablating method then protrudes into the fluid channel.

The use of the microstructures into the fluid channel has the effect of improving the efficiency of the temperature control plate in a targeted manner. The microstructures are thereby used on the one hand in respective fluid channel sections in order to influence boundary layers from the fluid to the cooler plate in a targeted manner. The friction between the fluid and the cooler plate can thereby be reduced in a targeted manner. The friction can be reduced by up to 10%, in that less interaction takes place between a main flow of the fluid channel or fluid channel section and a laminar boundary layer on the inner wall of the fluid channel. The microstructures can also be used in channel sections in a targeted manner in which, due to the topology of the fluid channel, turbulences occur, in order to reduce or to compartment said turbulences. Via the microstructures, the flow can also be influenced locally in a fluid channel section in such a manner that the energy exchange between the fluid and the inner wall is adjusted in order to have the temperature control capacity available elsewhere, thus for example to efficiently use a cooler main flow at heat peaks, so-called hotspots.

On the other hand, the microstructures can, for example, be used to locally excite vortices as so-called turbulators. In this case, the microstructures lead to a greater pressure loss across the fluid channel and to a greater heat transfer.

The microstructures can also be designed as guide structures for guiding the flow, for example at branches of the fluid channel. Here, an increase or decrease of the pressure loss can be designed by means of the microstructures. Furthermore, as described above, the microstructures, as so-called riblets or surface ribs, can calm or avoid vortices in a targeted manner, preferably having the same or less pressure loss across the fluid channel.

The microstructures can thereby respectively take different shapes or different relative arrangements to each other, so that the different flow characteristics can be considered locally and so that, for example, a cooling capacity of the cooling plate can be adapted to a distribution of heat generation of the element to be cooled.

Altogether, the described fluid container thus provides significant added value for the product family of temperature control plates, as an improved thermal transfer is possible, for example, an improved cooling effect under otherwise constant boundary conditions, for example a consistent topology. This in turn opens up a greater scope for design in the direction of higher energy density in the same installation space, for example for new power electronics or using new generations of energy storage, or allows greater power extraction from established battery cells. Unintended unequal temperature distributions, for example so-called hotspots, can be avoided in a targeted manner. This provides increased safety and life for the cooled batteries, especially when cooling a storage device for electrical energy, so-called battery cooler plates. Furthermore, a reduction of the pump power is possible by minimizing the resistance. This enables a more efficient operation of the entire system and thus, for example, a greater range of a motor vehicle having an electric or hybrid drive.

In an advantageous embodiment it is provided that the microstructures are at least partially, thus some of the microstructures or all microstructures, formed as surface ribs, the main extension thereof extending substantially along a flow direction of the fluid through the fluid channel. The surface ribs or riblets can thus proceed in the flow direction. This has the advantage that a flow resistance is reduced in the area of the microstructures and thus a heat transfer is influenced.

The surface fins have the advantage that vortex formation and thereby pressure loss are reduced in the fluid channel sections in which the surface ribs are present. In addition, in said areas, a heat transfer from or to the fluid to the environment, in particular the component being temperature controlled, is influenced, increasing the flexibility, that is, the adaptability of the fluid container to the component to be cooled.

It can thereby be provided that the surface ribs extend at least partially over the fluid channel, in particular over a large part of a branch-free section of the fluid channel. This has the advantage that the flow resistance is reduced in the corresponding section in a targeted manner.

In a further advantageous embodiment, it is provided that the microstructures are formed at least in sections as groups of surface ribs extending at least substantially parallel to a flow direction of the fluid through the fluid channel. Such surface ribs can also be referred to as parallel riblets. This has the advantage that the flow resistance is reduced in a larger region of the fluid channel.

In another advantageous embodiment, it is provided that the microstructures, at least in sections, thus at least in a fluid channel section of the fluid channel, viewed in cross section perpendicular to the flow direction of the fluid through the fluid channel, are respectively provided at least substantially, thus substantially or exactly, perpendicular to and at the inner wall. “Substantially” can be understood here as meaning “apart from a specified deviation”. The specified deviation can thereby be, for example, ±10°, ±5° or ±1°. This has the advantage that the microstructure can be introduced into the layer and thereby into the channel wall, in a simple manner with low material costs in the flat state of the layer, that is, when the layer does not yet have the recess for the fluid channel, and only afterwards the channel form can be formed over the layer.

In an alternative embodiment, it is provided here that the microstructures, viewed at least in sections in a flow direction of the fluid through the cross section perpendicular to the channel, have at least substantially parallel, that is, substantially or exactly parallel side flanks. Here, the corresponding deviation can again be ±10°, ±5° or ±1°. This has the advantage that in this case in the finished fluid channel, undercuts unable to be demolded are avoided, and thus the recess can first be formed in the layers and then the microstructures can be formed, for example by lazering.

The two aforementioned sections consider microstructures having a substantially rectangular or at least intermittently substantially rectangular cross section. In addition to these, however, other cross-sectional shapes of the microstructures are possible, such as structures that run at least partially on a wavy line or on sections of such, triangular profiles or trapezoidal profiles, in which the walls respectively run obliquely.

Particularly advantageous are microstructures , in particular microstructures having a substantially rectangular or at least intermittently substantially rectangular cross sectional shape, in which the width of the microstructures as determined in parallel to a surrounding surface of a fluid channel is larger than a height of the microstructures as determined orthogonal to the surrounding surface of a fluid channel.

While rectangular, trapezoid or triangular shapes are advantageous with respect to fluid mechanics, because the surface protruding into the fluid is particularly small, rounded-rectangular, rounded-trapezoid or rounded-triangular shapes are advantageous with respect to manufacturing.

The surface ribs or at least some of the surface ribs can have a height that is less than 500 μm, preferably less than 250 μm. A maximum height of the surface ribs or riblets can thus be specified. The surface ribs or at least some of the surface ribs can also have a height of at least 5 μm, preferably at least 10 μm, preferably at least 20 μm. A minimum height of the surface ribs or riblets can thus be specified. The dimensions mentioned have proven to be particularly advantageous for reducing the flow resistance in the fluid channel.

In a further advantageous embodiment, it is provided that, within a group of surface ribs extending substantially parallel to a flow direction of the fluid through the fluid channel, the distance between two closest surface ribs in the foot region and/or in the head region of the respective surface ribs is at least as great as the height of the lower of the two closest surface ribs and at most ten times the height of the higher of the two closest surface ribs. This design has also proven to be particularly advantageous for reducing the flow resistance in the fluid channel.

In an advantageous embodiment, it is provided that at least one group of surface ribs is arranged at least in sections along the flow direction of the fluid through the fluid channel, that the at least one group of surface ribs is or are present in said sections over at least 20% of the channel circumference, preferably 40% of the channel circumference. This proportion has been found to be sufficient for significantly reducing the flow resistance in the fluid channel.

The height of the microstructures can be understood here as the maximum height, for example if two side flanks of a microstructure are of different lengths due to an oblique arrangement of the microstructure on the inner wall of the fluid channel. The height can also be understood as the maximum distance of the microstructure from a tangent on the inner wall of the fluid channel at the foot of the microstructure. The dimensions mentioned here have proved to be particularly advantageous as they are particularly suitable for reducing vortex formation.

In another advantageous embodiment, it is provided that the surface ribs, at least in sections, have a lower height in an edge region, preferably two edge regions, of the fluid channel than in a center region of the fluid channel arranged between the edge regions. The edge and center region can thereby be arranged in the recess associated with the fluid channel. The edge and center region are thereby determined in a plane parallel to the main extension plane of the fluid container along a local flow direction of the fluid through the fluid channel. In a projection onto a plane parallel to the main extension plane of the fluid container, the above-described core of the fluid, which has a maximum flow velocity, can thus be projected onto the center region, whereas the regions of the fluid channel are projected on the edge region or regions, in which lower flow velocities occur. Alternatively, the microstructures can also have the same height and/or the same thickness, which involves manufacturing advantages.

In another advantageous embodiment, it is provided that the microstructures are at least partially, that is some of the microstructures or all microstructures, are formed as turbulators, which have, on their end downstream of the flow direction of the fluid through the channel, a (flow) tear-off edge for a flow of fluid (that is for the fluid flow). This has the advantage that, in the region of the microstructures, vortex formation is promoted, and a heat transfer is increased thereby.

It can be provided that the microstructures are at least partially formed as discrete, thus separate flow disturbance elements, which, starting from the region of their maximum width in the flow direction of the fluid through the channel, have a smaller extent parallel to this flow direction than against this flow direction. As a result of this design, vortex formation is promoted in the region of the microstructures and thus a heat transfer is increased.

It can also be provided that a plurality of turbulators are arranged in the flow direction of the fluid through the channel one behind the other, wherein the turbulators arranged one behind the other viewed in the flow direction can be arranged offset. The turbulators can thus have identical or different distances in the region of their maximum width relative to the side edges of the channel. This has the advantage that the vortex formation is increased further.

In another advantageous embodiment, it is provided that the fluid channel has a curvature in at least one fluid channel section in the flow direction of the fluid, wherein at least one, preferably a plurality of microstructures formed as lead structures are arranged in the region of the curvature. This has the advantage that the flow within the fluid channel can be specified more precisely, in particular can be guided to regions having increased temperature control requirement in a targeted manner. This in turn improves the design options for the heat transfer.

In a further advantageous embodiment, it is provided that the fluid channel has a branch in at least one fluid channel section in the flow direction of the fluid and/or a plurality of fluid channel sections merge in the flow direction of the fluid to form a fluid channel section, wherein, in the region of the branching and/or the merging of the respective fluid channel sections at least one, preferably a plurality of guide structures are arranged. This has the advantage that the flow can be directed into or out of a fluid channel section in a targeted manner and thus container regions having greater and smaller heat transfer can be created in a targeted manner.

In particular, it can be provided that the respective guide structures do not follow the direction of the curvature and/or the branching and/or the merging of the relevant fluid channel section.

In an advantageous embodiment, it is provided that all or at least part of the turbulators and/or the guide structures have a height that is at least 1/10 of the channel height at the respective position of the turbulator or of the guide structure, preferably at least ⅕ or at least ⅓ or at least ½ of the channel height at the respective position of the turbulator or of the guide structure. Thereby it can be ensured that the turbulators and/or the guide structures protrude sufficiently into the (core) flow of the fluid in order to achieve the mentioned effects to a particularly pronounced degree. In another advantageous embodiment, it is provided that the microstructures are partially formed as surface ribs and/or partially as turbulators and/or partially as guide structures. Thereby, the flow conditions and thus the heat transfer can be designed particularly flexible and independent of the course of the fluid channel. This has the advantage that the flow behavior can be adapted particularly well to the respective requirements.

In a further advantageous embodiment, it is provided that the turbulators extend only in sections over the fluid channel, that they are arranged in particular in a region section of the fluid channel in the flow direction in front and/or behind a region section having surface ribs. Thus, if the microstructures are partially formed as surface ribs and partially as turbulators, then it is preferably provided that the turbulators extend only in sections over the fluid channel and are arranged in particular in a section of the fluid channel in the flow direction in front of and/or behind a section having surface ribs.

Thus, at a point X in the flow, a turbulator can be seated, alternatively at point X in the flow, a plurality of turbulators arranged in a row perpendicular to the flow direction can be seated, and at a specified distance behind it/them one or more surface ribs. By means of the turbulator(s), a turbulence is then generated at the point X in a targeted manner, in order to enable a particularly large heat transfer locally, for example to cool a hotspot in a targeted manner. Shortly thereafter, the resulting vortices are calmed by the surface ribs and thus the friction losses are minimized and thus the total energy required is minimized. Thereby, sections, in which only substantially rectilinear or slightly corrugated surface ribs are present, can be used deliberately over longer sections compared to the sections having the turbulators to there minimize the heat transfer to or from the fluid and thus to realize low energy and pressure losses. By means of the turbulators, a counter-vortex can also be generated in a targeted manner for a vortex to be compensated, for example, by the topology of the fluid channel, such as a branching of the fluid channel. The energy required to calm the vortex is thereby about 20% of the energy contained in the vortex.

In a further advantageous embodiment, it is provided that at least one layer of the at least two layers of the temperature control plate is a metallic layer or a plastic layer and that the microstructures are at least partially, thus partially or completely, formed in the at least one metallic layer or the plastic layer, in particular embossed or are introduced in a rolling manner. This has the advantage of a particularly cost-effective and fast manufacture.

In another advantageous embodiment, it is provided that the at least one layer is a metallic layer and that the microstructures at least partially, thus partially or completely, are introduced into the at least one metallic layer in an ablating manner, in particular by means of laser or by etching. The overhangs of the metallic layer remaining after the ablating, which protrude into the fluid channel then form the respective microstructures. This has the advantage that the microstructures can be manufactured particularly accurately and small.

In a further advantageous embodiment, it is provided that the at least one layer is a plastic layer and that the microstructures are introduced at least partially during the original forming of the layer, in particular during injection molding of the layer. This has the advantage that the production is particularly easy, cheap and fast.

In another advantageous embodiment, it is provided that the at least one layer is a metallic layer or a plastic layer and that the microstructures are applied at least partially, thus all microstructures or only a part of the microstructures, in particular by means of lithography and/or 3D printing and or by means of applied and laser-fused powder and/or by means of plasma.

A temperature control plate can be formed in two layers on its own, even if it is made of a continuous sheet metal layer, wherein two sections of the sheet metal layer are folded on each other.

It can be provided that the surface ribs extend at least in sections over the fluid channel, in particular over a large part, for example more than 50%, more than 70% or more than 90% of the length of a branch-free section of the fluid channel, which can also be referred to as a fluid channel section. Thereby, the surface ribs can also be interrupted surface ribs, so that the region, in which the surface ribs are present, extends over the large part of the length of the branch-free section of the fluid channel. This has the advantage that a reduced friction is achieved in the respective fluid channel section.

It can also be provided to achieve a “thread-like” arrangement by means of a plurality of guide structures extending at least substantially parallel to one another, but obliquely to the flow direction, which then causes the fluid flow to rotate in the corresponding section and thus promotes heat transfer between the fluid and the inner wall of the fluid container and thus the component that needs to be temperature controlled.

In a further advantageous embodiment it is provided that the microstructures are at least partially formed as turbulators, the main extension thereof extending transversely to a flow direction of the fluid through the channel and/or the length thereof in the direction of the main extension direction being at most twice, in particular at most 1.5 times of the width perpendicular to the main extension direction. If the turbulators have a main extension direction, then this can be at least substantially perpendicular to the flow direction, that is, for example, having a deviation of ±10°, ±25° or ±40°. This has the advantage that vortices and thereby heat transfer between the fluid and the component being temperature controlled can be promoted in a targeted manner.

In a further advantageous embodiment, it is provided that the recess is embossed into the layer and at least one shaping radius, in particular all shaping radii of the recess are adapted to the material of the layer in such a manner that a formation-induced, in particular an embossment radius induced, local thinning of the shaped layer is less than 15%, in particular less than 10% or less than 8% or less than 5%, particularly preferably less than 4%. The shaping radii of the recess can be specified viewed in a local cross-section perpendicular to the flow direction of the fluid through the fluid channel. This has the advantage that the microstructures can be formed from the layer in an ablating manner, and the overall thinning of the shaped layer remains uncritical. Moreover, by means of varying flank angles, the friction can also be reduced.

In another advantageous embodiment, it is provided that the recess associated with the fluid channel, viewed in the cross section perpendicular to a flow direction of the fluid through the fluid channel, has a first convex edge region on the inner wall or side of the fluid channel, which passes into a first concave center region with or without passing through a straight connecting region, wherein the concave center region in turn passes either directly into a second convex edge region or into a straight central region, which in turn passes into another concave center region, which in turn, with or without passing through another straight connection region, passes into the second convex edge region. Here, the described microstructures, in particular the turbulators or guide structures, offer the advantage that turbulences can be avoided even in the case of very large shaping radii in the joint between the layers, and thus overall advantageous fluid dynamics are achieved.

The microstructures of the surface mentioned above can also be used for the coolant channels of separator plates in fuel cells or fuel cell stacks. In particular, the series connection of turbulence-generating turbulators and turbulence-reducing surface ribs can also lead to a locally improved cooling there.

The features and combinations of features mentioned above in the description as well as the features and feature combinations mentioned below in the description of the figures and/or shown alone in the figures can be used not only in the respectively specified combination but also in other combinations, without departing from the scope of the invention. Therefore, also embodiments of the invention not explicitly shown or explained in the figures but emerging from and generated by separate feature combinations of the described embodiments are to be viewed as encompassed and disclosed. Embodiments and combinations of features are also to be viewed as disclosed, which thus do not have all the features of an originally formulated independent claim. Furthermore, embodiments and feature combinations exceeding and/or differing from the feature combinations set out in the claims, in particular by the embodiments set out above, are also to be viewed as disclosed.

Exemplary embodiments of the invention are shown in the following by means of schematic drawings. Shown are:

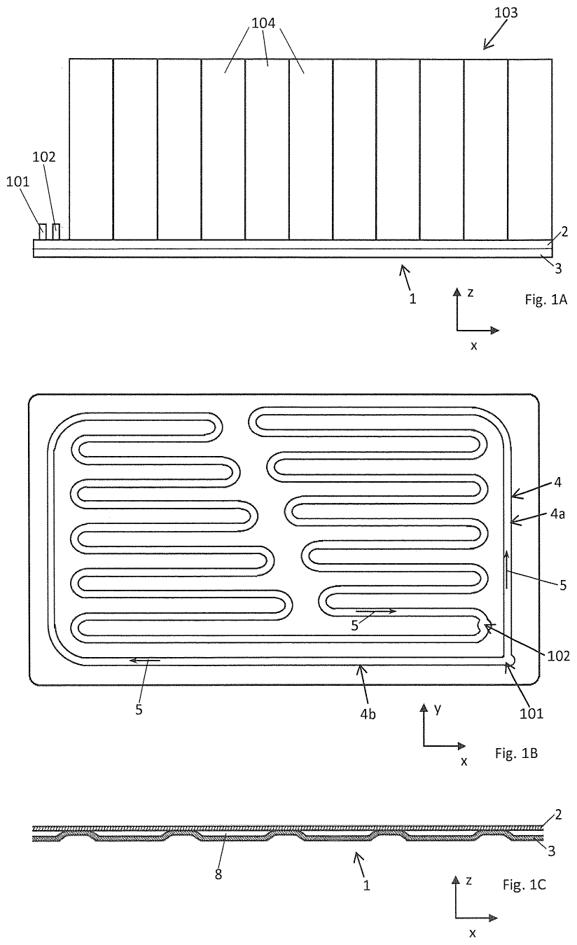

FIG. 1 in partial images 1A, 1B and 1C a side view, a plan view and a sectional view of an exemplary plate-like fluid container, on which battery cells are arranged in the partial image 1A;

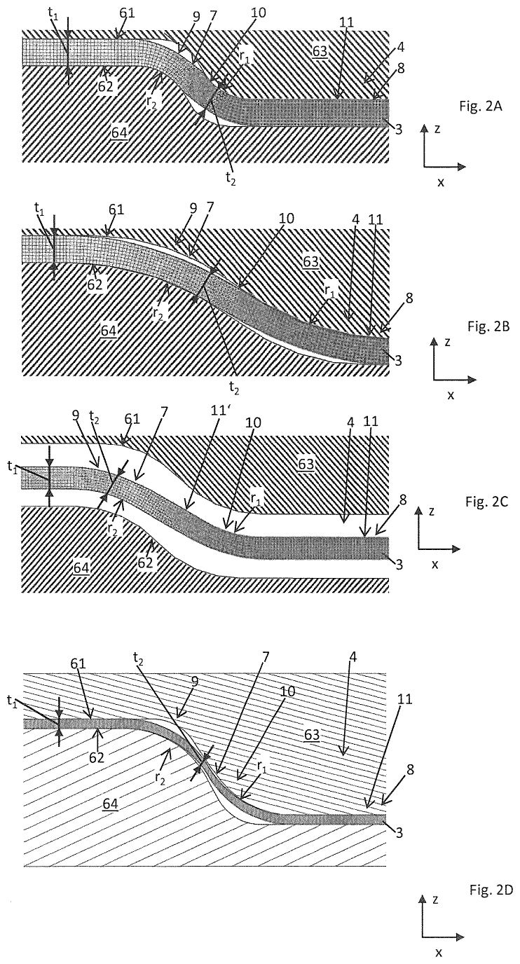

FIG. 2 in the partial images 2A, 2B, 2C and 2D respective partial sectional views perpendicular to the main extension plane of the plate-like fluid container and perpendicular to a flow direction through the fluid channel having strong flank tapering and small shaping radii and reduced flank tapering and larger shaping radii, as well as a straight spacer;

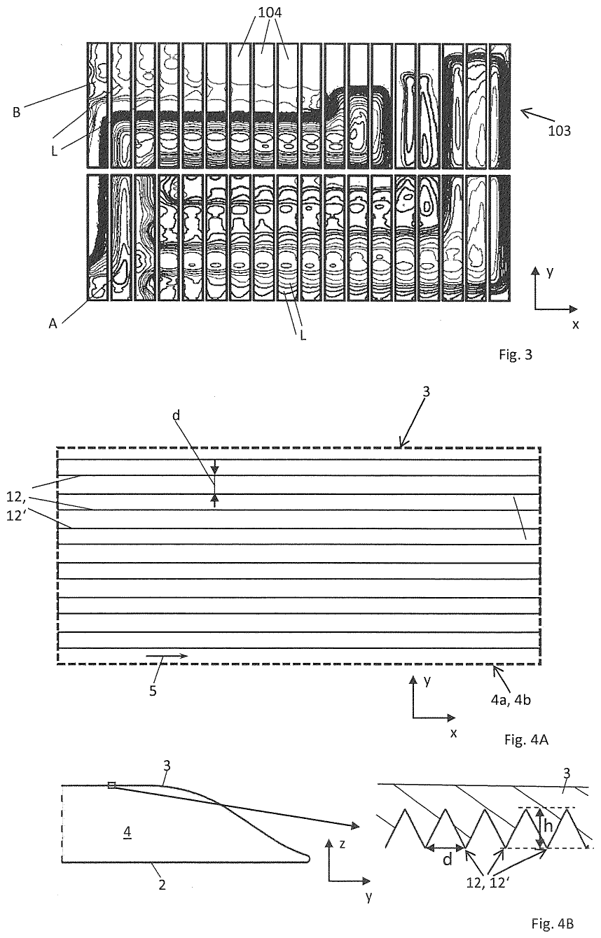

FIG. 3 an exemplary heat distribution in battery cells of a battery pack arranged on a plate-like fluid container according to the prior art;

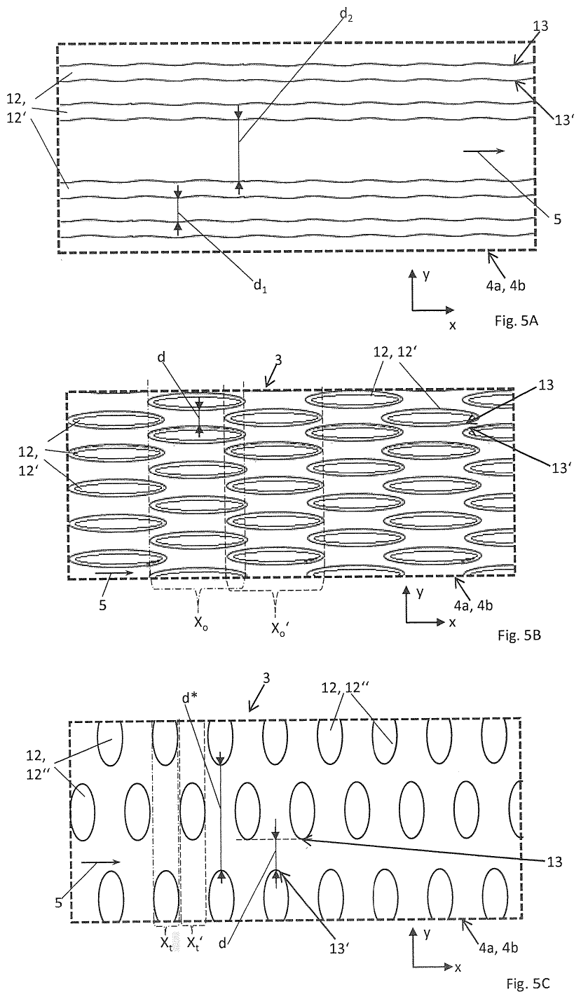

FIG. 4 an exemplary example of microstructures in a fluid channel in an overview (partial image 4A) and in a detailed view (4B);

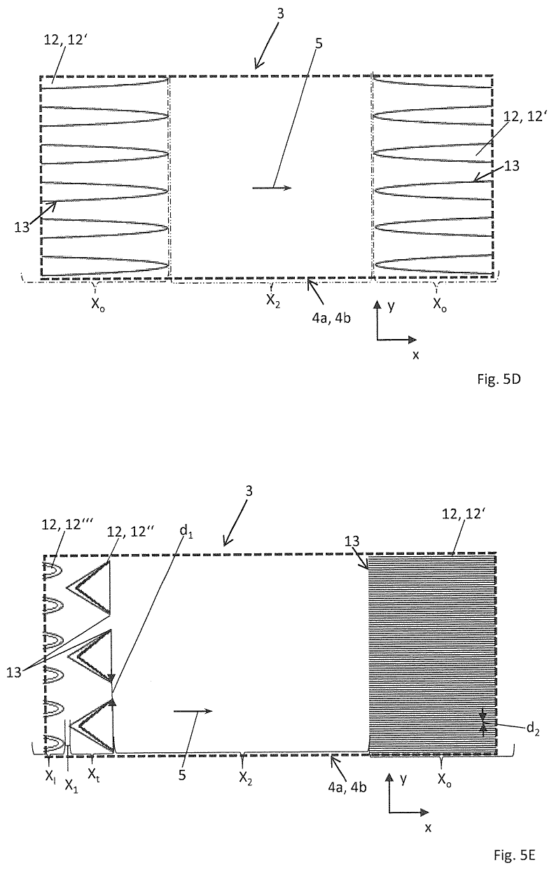

FIG. 5 in the partial images 5A to 5F respectively different microstructures of various forms and arrangements and a detailed representation in partial image 5G; as well as

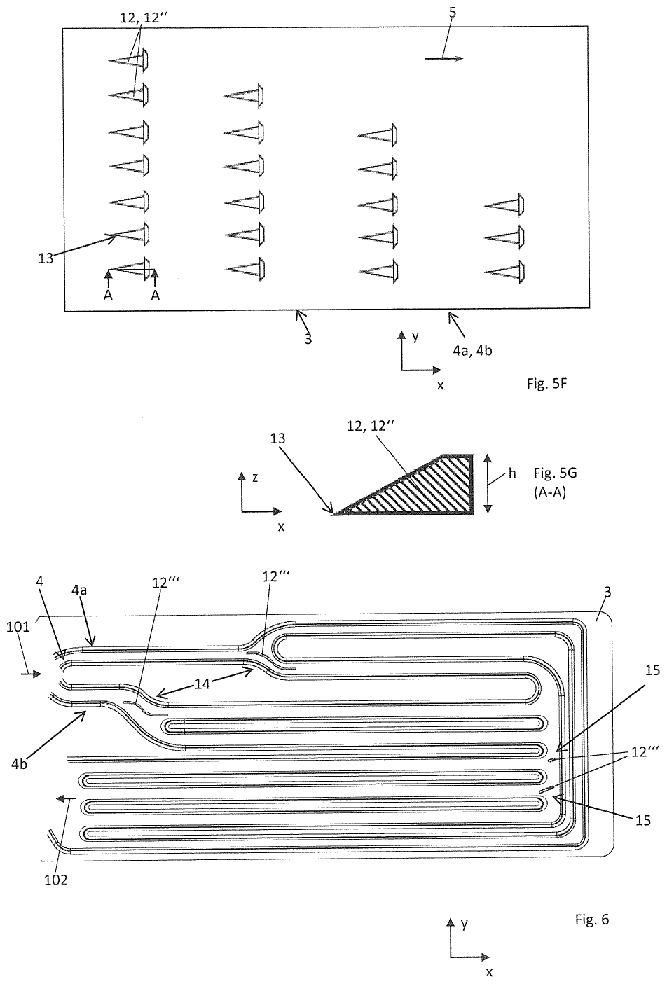

FIG. 6 an exemplary course of a branching fluid channel in a plan view of a layer of the plate-like fluid container; and

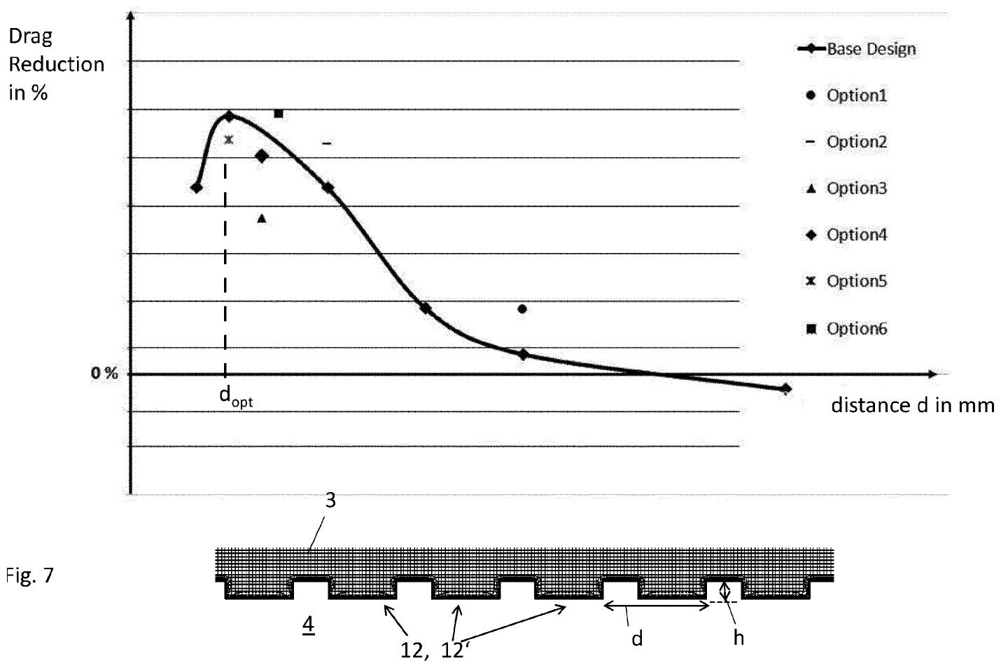

FIG. 7 a partial cross section of a layer of a further plate-like fluid container and a graph showing the dependency of relative fluid resistance from distance between microstructures.

Identical or functionally identical elements are thereby provided with the same reference numerals.

The scales, in particular the detailed representations of surface fins, turbulators and lead structures are not identical.

FIG. 1 shows a side view of a fluid container 1 in partial image 1A, namely presently of a battery temperature control plate 1 having a first upper layer 2 and a second lower layer 3. In the example shown, the lower layer 3 has at least one recess 8 (partial image 1C) on its side facing the first layer 2, which specifies the course of a fluid channel 4. A battery pack 103 having battery cells 104 is arranged on the upper layer 2. The battery pack 103 and the temperature control plate 1 are thereby in a heat conduction contact. The temperature control fluid is introduced into the fluid channel 4 of the temperature control plate 1 from a supply line via an inlet socket 101 arranged at an end of the temperature control plate 1. The fluid channel 4 branches in the example shown in partial image 1B into two channel sections 4a and 4b, which presently respectively couple the inlet 101 to the outlet 102 in a fluid manner. The flow direction 5 of a fluid introduced via the inlet 101 into the fluid channel 4 is respectively designated by arrows here. In the partial image 1C, the first layer 2 and the second layer 3 having the recess 8 are shown in a sectional representation.

In FIG. 2A, a partial section through one of the layers, presently the second layer 3, is represented perpendicular to the flow direction. The layer 3 is thereby a sheet metal layer, into which microstructuring has not been introduced yet. The actual course of layer 3 can be seen from the hatched cross section. The layer 3 is still in the tool, where the entire shaping has already taken place. The lines 61, 62 represent the course of the contours of the tools 63, 64. The sheet metal contours thereby do not about the tools continuously, the shape rather results through partial abutment in combination with a drawing of the material.

A thinning of the material results thereby from the difference between the original sheet metal thickness t₁ and the sheet metal thickness t₂ in the deformed area. This is particularly large in the area of the shaping radius r₁. The thinning (t₁−t₂)/t₁ is thereby presently approximately 10%. At the inner side or inner wall 7 of the fluid channel 4, the recess 8 has a first convex edge region 9, which presently passes into a first concave central region 10 without passing through a straight connecting region. The concave central region 10 presently passes into a straight center region 11 on its part. The complete fluid channel 4 (without considering the first layer 2) results here through a mirror-symmetric continuation of the shown cross section, whereby the straight center region 11 then passes into a further concave central region, which passes into a second convex edge region on its part.

In FIG. 2B, the analog situation is represented by clearly larger shaping radii r₁, r₂. The thinning (t₁−t₂)/t₁ realized in the layer 3 is thereby substantially smaller, presently less than 3%.

In FIG. 2C, the tools 63, 64 are already partially opened again after forming. Here, the shaping radii r₁, r₂ are again smaller in comparison with FIG. 2B, but presently, there is a straight intermediate region 11′ between the convex edge region 9 and the concave central region 10. The thinning (t₁−t₂)/t₁ realized in the layer 3 is comparable to that of FIG. 2B, thus less than 3%.

In the examples of FIG. 2A to 2C, the sheet metal of the layer 3 has only a slight thinning, so that no overloading of the sheet metal occurs during the subsequent or simultaneous introduction of microstructures by means of ablating methods or forming methods and the microstructured fluid channels do not have any disadvantages in terms of tightness and durability, for example, with respect to fluid channels without microstructuring.

By contrast, FIG. 2D represents a conventional tool having a sheet metal layer 3, in which the forming of the fluid channel leads to a significantly more pronounced thinning of the layer 3. The thinning (t₁−t₂)/t₁ here is about 40%, so that this basic form is only conditionally suitable for forming microstructures or even ablating material for producing microstructures.

In FIG. 3, an exemplary heat distribution in battery cells 104 of a battery pack 103 arranged on a plate-like fluid container according to the prior art is represented. The highest heat is present in area A, the lowest heat in area B. The gradations between the highest and lowest heat are thereby marked in the projection in the form of isotherms L. The heat distribution in the battery pack is very inhomogeneous and can reach up to 15 K difference and correspondingly in the associated fluid container up to 10 K. However, it has been shown that various aging effects already occur from 5 K difference in the battery pack, whereby the performance of the battery pack is reduced.

In FIG. 4A and 5A to 5F, respective fluid channel sections 4a, 4b, which can also extend over the entire fluid channel 4, are respectively shown in a plan view of corresponding microstructures 12, 12′, 12″, 12″′. Thereby, the respective layer 3 can respectively still be straight, that is, with regard to the recess 8 un-deformed, that is, having the microstructures but still not having the recess 8, or already having both the recess 8 and the microstructures 12, wherein, in the figures, a projection of the microstructures 12′ on the main extension plane of the fluid container 1 is respectively represented.

FIG. 4A shows straight microstructures 12 designed as surface ribs 12′ arranged equidistantly at a distance d parallel to the flow direction 5. The microstructures 12 thereby presently extend continuously over the entire length of the section 4a, 4b shown in the x-direction.

In FIG. 4B, a cross section through one half of an exemplary fluid channel 4 is represented on the left, on the right an enlarged cross section through the microstructured layer 3. The length of the solid lines representing the layers 2, 3 of FIG. 4B on the left corresponds to half of the channel circumference of the fluid channel 4. In FIG. 4B on the right, microstructures 12, 12′ are represented having a triangular cross-sectional shape. The distance d of the microstructures 12, 12′ can be given here and also in the other examples by the distance of the head regions of the respective microstructures 12. In the example shown, the distance d is given by the distance of the peaks of the surface ribs 12′ protruding into the fluid passage 4. However, the distance d can also be given with the distance of the side flanks of the respective microstructures 12 at half height or else, if in the foot region other than present here, no direct transition between adjacent surfaces ribs 12′ takes place, be given in the foot region. In the example shown, the height h is perpendicular to the distance d and is given by the maximum (perpendicular to the distance d) distance of a point in the head region of the microstructure 12 from a point in the foot region of the microstructure 12.

Depending on the curvature of the recess 8 of the inner wall 7 thereof, there may be small deviations from the right angle in other arrangements.

In FIG. 5A, the microstructures 12 designed as surface ribs 12′ also extend continuously over the entire length of the guide channel section 4a, 4b, but are spaced apart at different distances d₁, d₂, wherein the distances d₁, d₂ are measured between the side flanks 13, 13′ of the respective surface ribs 12′. In the example shown, the surface ribs 12′ have a rectangular cross-section, in contrast to the example of FIG. 4A. In addition, in the example shown, one is faced with corrugated surface ribs which extend in a wavy line parallel to the flow direction 5 over the fluid channel section 4a, 4b.

In FIG. 5B, the respective microstructures 12 designed as surface ribs 12′ do not extend over the entire length of the guide channel section 4a, 4b, but in each case only the respective main extension direction thereof over a partial region Xₒ, Xₒ′, parallel to the flow direction 5. The respective partial region Xₒ, Xₒ′ thereby makes up a fraction, presently approximately one fifth of the guide channel section 4a, 4b shown. Thereby, a plurality, presently five or six of the microstructures 12 are arranged in a row parallel to the flow direction in each partial region Xₒ, Xₒ′. The microstructures 12 arranged in the respective partial region Xₒ′ adjoining a partial region X perpendicular to the flow direction 5 are thereby arranged offset from the preceding microstructures 12 of the partial region Xₒ. The partial regions Xₒ, Xₒ′ can thereby also overlap in the flow direction as shown, for example in an area having less than 10% or less than 5% of their surface area each. In the flow direction, the partial regions Xₒ, Xₒ′ can continue alternately over a section of the fluid channel, symbolically sketched here. In a plan view of the layer 3, the microstructures 12 presently have the same contour or basic shape, as is also the case in the examples shown above. In the surface ribs 12′ shown in FIG. 5B, this is an elliptical contour. The distance d perpendicular to the flow direction 5 is thereby presently measured again between the side flanks 13, 13′, more precisely at the foot region, and namely for the surface ribs 12′ of a region Xₒ, Xₒ′ perpendicular to the flow direction 5.

In FIG. 5C, interrupted microstructures 12 are also represented in the flow direction 5, which, however, are presently designed as turbulators 12″. Correspondingly, the microstructures 12 presently also provided with an elliptical contour are arranged transversely to the flow direction 5 in the main extension direction thereof. In the respective partial regions Xₜ, Xₜ′, which are located one behind the other in the flow direction, here, as was also the case in FIG. 5B, shown here in the partial region Xₜ two microstructures 12 and in the partial region Xₜ′ one microstructure 12 are arranged, preferably arranged parallel to their main extension directions. The microstructures of a partial region Xₜ, Xₜ′ are thereby presently arranged transversely to the flow direction 5 at an increased distance d*. The increased distance d* corresponds to twice the distance d of the turbulators 12″ of the partial regions Xₜ, Xₜ′ which one relative to the other are closest to each other transverse to the flow direction plus the extension of a microstructure 12 transverse to the flow direction 5.

In FIG. 5D, a plurality of microstructures 12 formed as surface ribs 12′ are arranged adjacent to each other in partial regions X, the respective main extension direction thereof being parallel to the flow direction 5. These again presently have an elliptical basic shape. In a partial region X₂ between the partial regions Xₒ, no microstructures 12 are present in the present example.

In FIG. 5E, a plurality of microstructures 12 formed as guide structures 12″′ are arranged adjacent to each other in the partial region X₁ the respective main extension direction thereof being parallel to the flow direction 5. These presently have an elliptical basic shape, wherein said guide structures 12″′ are not shown over their entire length.

The partial region X₁ is followed by a further partial region X₁, in which no microstructures 12 are provided in the present example. In a further partial region Xₜ, which adjoins the partial area X₁, turbulators 12″ are arranged for swirling the fluid. The turbulators 12″ are arranged at a distance d₁ to each other. The turbulators 12″ are thereby arranged offset to the guide structures 12″′ viewed transversely in the flow direction 5, so that the guide structures 12″′ guide the fluid directly to the turbulators 12″. The turbulators 12″ thereby presently have a triangular base surface, having a peak opposite to the flow direction 5 and a base surface, on which a flow tear-off is provoked by means of a tear-off edge, oriented perpendicular to the flow direction 5. Thereby, an intensified vortex formation and thus an increased heat transfer, for example an increased cooling, is generated directly adjacent to the partial area Xₜ.

The partial area Xₜ is again adjoined by a partial area X₂, in which no microstructures 12 are present in the present case. In the region Xₒ which adjoins the region X₂ in the flow direction downstream, microstructures 12 are again designed as surface ribs 12′, which trap or reduce the turbulences intentionally formed on the turbulators or triangular microstructures 12″. The distance d₂ of the closest surface ribs 12′ is thereby substantially smaller than the distance d₁ of the closest turbulators 12″ in the region Xₜ.

In FIG. 5F are represented further exemplary arrangement possibilities for microstructures 12 designed as turbulators 12″. The turbulators 12″ are thereby arranged in rows transversely to the flow direction 5, wherein the rows can have different numbers of turbulators 12″, for example seven, six, five or three turbulators 12″. Correspondingly, the rows of the turbulators 12″ can extend only partially but also completely across the width of the fluid channel 4. Said rows can be arranged in the flow direction 5 at different distances, in order to promote turbulences and thus heat transfer at desired locations in a targeted manner.

The turbulators 12″ shown are particularly suitable for generating turbulence due to their contour. The contour is presently formed by an isosceles triangle and a trapezoid as the base body, the trapezoid connecting to the longer of the two parallel sides to the base side of the triangle. The tip of the triangle is oriented counter to the flow direction 5, and the trapezoid forms a tear-off edge for the flow. The contours of the turbulators 12″ are presently also formed symmetrically with respect to the flow direction 5.

FIG. 5G represents a section through a turbulator 12″ along the line A-A in FIG. 5F. It can be seen here that the height of the turbulator 12″ in the upstream part (the isosceles triangle in plan view) increases in the flow direction and proceeds constantly to the downstream end. The downstream end then drops vertically at 90°.

The exemplary embodiments shown in FIGS. 4A and 5A to 5F can also be understood as sections of a recurring pattern. Thus, the shown pattern of the microstructures 12 can repeat and extend arbitrarily in the x and/or y direction.

FIG. 6 shows a plan view of an exemplary branching fluid channel 4 in a plan view of a layer 3 of the plate-like fluid container. Thereby, respective guide structures 12″′ are presently arranged in the fluid channel 4 at locations of branches 14 and/or branches 15. The guide structures 12″′ serve to quantitatively control the flow volumes into the different branches of the fluid channel 4 at the locations of the branches 14 or the branches 15. In the present example, an S-shaped contour was selected at the branches 14 for the guide structures 12″′, at the branches 15 a straight contour in the manner of baffles.

In an analogous manner to FIG. 4B, FIG. 7 in its lower part discloses a layer 3 with microstructures 12, 12′ of a fluid container according to the invention in a partial cross section. The microstructures 12, 12′ have a rectangular cross sectional shape. The distance d between the microstructures 12, 12′ may here and in other examples be defined by the width of one repeating unit of the microstructures 12. In the shown example this corresponds to the distance d, which is defined by the distance between the centers of neighbouring tips/protrusions or end sections of the surface ribs 12. Distance d may however also be determined by the distance of corresponding side flanks of neighboring microstructures 12 at their half height or, if there is no direct transition between neighboring surface ribs 12′, at the footing area. In this example, both definitions result in identical values for the distance d, because the side flanks of the microstructures 12, 12′ extend in parallel to each other. In this example the height h is perpendicular to the distance d and is defined by the maximum distance (in a direction perpendicular to the distance d) between any of the points in the head area of the microstructure 12 and any of the points in the foot area of or immediately besides the microstructure 12. Depending on the curvature of the recess 8 or its inner wall (see e.g. FIGS. 1A-2C) small deviations from the rectangular angle may happen in other arrangements.

In the upper partial figure of FIG. 7, the influence of the distance d (abszissa, in mm) on the reduction of drag/flow resistance (ordinate, in %) in the fluid channel of the microstructures 12, 12′ with rectangular cross sectional shape compared to a smooth fluid channel is plotted in % relative to an arbitrary base line (line indicated as “0%”). The reduction of the flow resistance is shown for microstructures 12, 12′ with a rectangular cross sectional shape keeping other dimensions unchanged, i.e. with same height h and width b of microstructures 12, 12′ a straight line with rhomb like data points and designated as “Base Design”. This curve shows, that for microstructures 12, 12′ with predetermined shape an optimum distance dₒₚₜ between neighboring microstructures 12, 12′ exist, at which the drag is reduced most.

For comparison 6 different cross sectional shapes of microstructures are also measured, however only with single values. It has been confirmed (not shown in FIG. 7), that these designs, named “Option 1” to “Option 6”, show a similar dependency of the relative flow resistance from distance d as the microstructures 12, 12′ with rectangular cross sectional shape of the Base Design.

Thus FIG. 7 demonstrates, that there exist parameter sets, e.g. distances d, which increase the relative flow resistance. This is the reason, why parameter sets, i.e. shape and/or height h and/or width b and/or distance d, should be selected preferably in dependency of viscosity and mass flow of the fluid, and by this in dependency from fluid and/or pressure and/or temperature and/or density and/or fluid channel cross section and/or fluid velocity.

1. A plate-like fluid container for guiding a fluid, comprising:
two layers abutting each other at least in regions,
an inlet for inlet of the fluid into the fluid container, and
an outlet for discharging the fluid from the fluid container, at least one fluid channel associated with the recess for guiding the fluid from the inlet to the outlet positioned between the layers along at least one recess positioned in at least one of the layers,
wherein the fluid channel has a plurality of microstructures protruding into the fluid channel on an inner wall.

2. The fluid container according to claim 1, wherein the microstructures are at least partially formed as surface ribs extending substantially along a flow direction of the fluid through the fluid channel in the main extension direction thereof.

3. The fluid container according to claim 1, wherein the surface ribs extend at least partially over the fluid channel.

4. The fluid container according to claim 1, wherein at least in sections, the microstructures are formed as groups of surface ribs proceeding at least substantially parallel to a flow direction of the fluid through the fluid channel.

5. The fluid container according to claim 2, wherein the surface ribs or at least some of the surface ribs have a height of less than 500 μm.

6. The fluid container according to claim 2, wherein the surface ribs or at least some of the surface ribs have a height of at least 5 μm.

7. The fluid container according to claim 2, wherein in a group of surface ribs extending substantially parallel to a flow direction of the fluid through the fluid channel, the distance between two closest surface ribs is at least as great as the height of the lower of the two closest surface ribs and at most ten times the height of the higher of the two closest surface ribs.

8. The fluid container according to claim 2, wherein the at least one group of surface ribs is or are arranged at least in sections along the flow direction of the fluid through the fluid channel so that the at least one group of surface ribs is arranged in said sections over at least 20% of the channel circumference.

9. The fluid container according to one of claim 1, wherein the microstructures are at least partially formed as turbulators, which have a tear-off edge for a flow of the fluid on the downstream end thereof in the flow direction of the fluid through the channel.

10. The fluid container according to claim 9, wherein at least in sections, the microstructures are formed as discrete flow disturbing elements which in the flow direction of the fluid through the channel have a smaller extension parallel to the flow direction than counter to the flow direction, starting from the region of the maximum width of the flow disturbing element.

11. The fluid container according to claim 9, wherein a plurality of turbulators are arranged successively in the flow direction of the fluid through the channel, wherein the successively arranged turbulators viewed in the flow direction are arranged offset to one another.

12. The fluid container to claim 1, wherein the fluid channel has a curvature in at least one fluid channel section in the flow direction of the fluid, wherein at least one microstructure formed as guide structure is arranged in a region of the curvature.

13. The fluid container according to claim 1, wherein the fluid channel has a branch in at least one fluid channel section in the flow direction of the fluid, or a plurality of fluid channel sections merge into a fluid channel section in the flow direction of the fluid, wherein at least one guide structure is arranged in the region of the branching and/or the merging of the fluid channel sections.

14. The fluid container according to claim 12, wherein the respective guide structures do not follow the direction of the curvature and/or the branching and/or the merging of the respective fluid channel section.

15. The fluid container according to claim 9, wherein all or at least part of the turbulators have a height of at least 1/10 of the channel height at the respective position of the turbulator.

16. (canceled)

17. The fluid container according to claim 9, wherein the turbulators are arranged in a region section (Xₜ) of the fluid channel in the flow direction before and/or behind a region section having surface ribs.

18. The fluid container according to claim 1, wherein the at least one layer is a metallic layer or a plastic layer and the microstructures are at least partially formed in the at least one metallic layer or the at least one plastic layer.

19. The fluid container according to claim 1, wherein the at least one layer is a metallic layer and the microstructures are at least partially embossed into, rolled into or ablated from the at least one metallic layer.

20. The fluid container according to claim 1, wherein the at least one layer is a plastic layer and the microstructures are at least partially introduced during the original forming of the layer.

21. The fluid container according to claim 1, wherein the at least one layer is a metallic layer or a plastic layer and the microstructures are at least partially applied by lithography, powder applied by laser, 3-D printing, or plasma.

22. The fluid container according to claim 1, wherein the recess is shaped into the layer and at least one shaping radius, in particular all shaping radii, of the recess are adapted to the material of the layer in such a manner that a thinning of the shaped layer is less than 15%, in particular less than 10%, in particular less than 8%, preferably less than 5%, particularly preferably less than 4%.

23. The fluid container according to claim 1, wherein the recess associated with the fluid channel has a first convex edge region in the cross section perpendicular to a flow direction of the fluid through the fluid channel on the inner wall of the fluid channel passing into a first concave center region with or without passing through a straight intermediate region, the concave central region in turn either passes directly into a second convex edge region or into a straight center region, in turn passing directly into a further concave center region, in turn passing into the second convex edge region with or without passing through a straight intermediate region.
